(19) United States
(12) Patent Application Publication
(10) Pub. No.: US 2012/0110060 A1
(43) Pub. Date: May 3, 2012

(54) NETWORK STATION SYSTEM WITH FUNCTIONS OF MEDIAL REGISTER NUMBER AND MEDICAL MESSAGES INFORMING

(76) Inventors: Chui-Huang Pan, Taipei (TW); Hsien-Wen Chang, Taipei (TW)

(21) Appl. No.: 12/938,367

(22) Filed: Nov. 2, 2010

(51) Int. Cl. G06F 15/16

(52) U.S. Cl. 709/203

(57) ABSTRACT

A network station system with functions of medial register number and medical messages informing comprises a server having a memory, a CPU, and input/output devices; at least one electronic device of a medical organization; the electronic device being connected to the server; the medical messages including the current register number, the predicted treating speed, the related information about the medical organization, the working time of the doctors; a central network unit; the central network unit being connected to the at least one electronic device for receiving the information from the electronic device; these information being displayed or transferred to those needed these information; and at least one patient computer device connected to the central network unit. A patient receives information of register numbers, medical information of medical organizations and advertisements from wired or wireless transmission so as to predict the timing for going to the medical organization.

### FIELD OF THE INVENTION

The present invention relates to medical services, in particular to a network station system with functions of medial register number and medical messages informing. A patient can get the information of register numbers, other medical information of the medical organizations and advertises from wired or wireless transmission so as to predict the proper timing for going to the medical organization. Thus the patient can save the waiting time in the medical organization.

### BACKGROUND OF THE INVENTION

More and more people registers to medical organizations, but they only know the register numbers thereof. They can't know the current register number for the patient that the doctors treat. Thus, patients must arrive the hospital early to wait the doctor for being treated. Not only the time is wasted, but also many bacteria will infect the patient.

Moreover, many patients can not know the messages of the medical organizations, such as working time of a doctor and treating room of the doctor and others. This causes that the patient goes to a medical organization in vain and thus time is consumed.

### SUMMARY OF THE INVENTION

The object of the present invention is to provide a network station system with functions of medial register number and medical messages informing. A patient can get the information of register numbers, other medical information of the medical organizations and advertises from wired or wireless transmission so as to predict the timing for going to the medical organization. Thus the patient can save the waiting time in the medical organization.

To achieve above object, the present invention provides a network station system with functions of medial register number and medical messages informing, comprising: a server having a memory, a central processing unit (CPU), and other related input/output devices; the memory storing the data about operation software, data about medial organizations, advertise providers, and patient; at least one electronic device of a medical organization; the electronic device being connected to the server; the medical organization transferring messages to the server through a network; the medical messages including the current register number, the predicted treating speed, the related information about the medical organization, the working time of the doctors; a central network unit; the central network unit being connected to the at least one electronic device for receiving the information from the electronic device; these information being displayed or transferred to those needed these information; and at least one patient computer device connected to the central network unit for receiving the data from the central network unit.

The various objects and advantages of the present invention will be more readily understood from the following detailed description when read in conjunction with the appended drawing.

### BRIEF DESCRIPTION OF THE DRAWINGS

FIG. 1 is a system structure of the present invention.

FIG. 2 is an operation flow diagram of the present invention.

FIG. 3 is an operation flow diagram of the present invention, in that advertises are added to the operation.

FIG. 4 shows the connection of a protocol unit to the present invention.

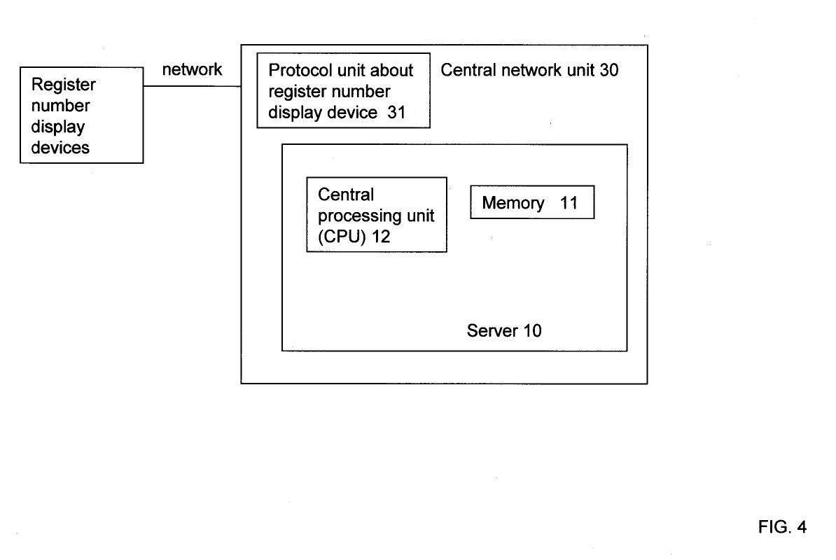

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

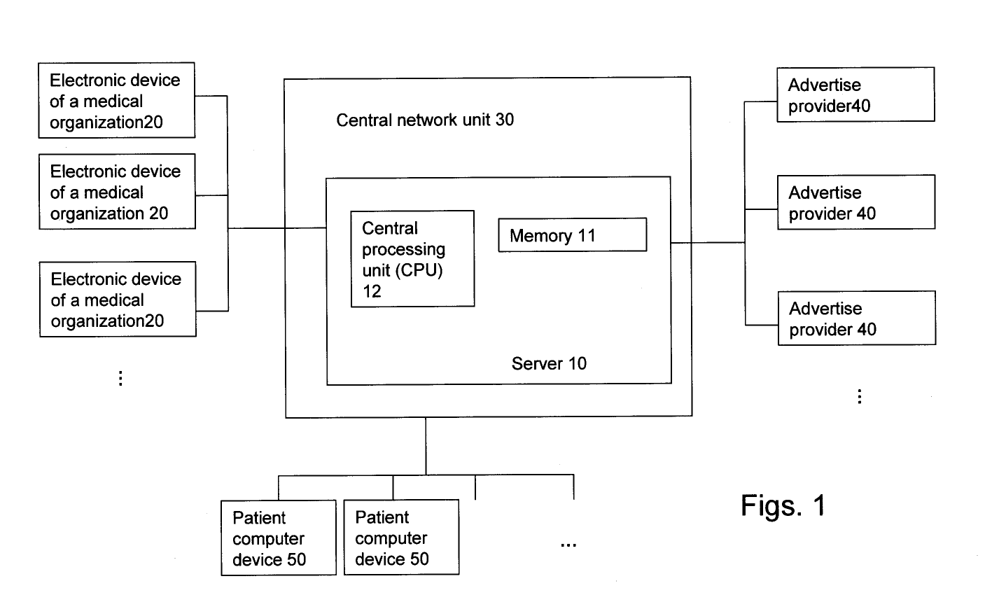

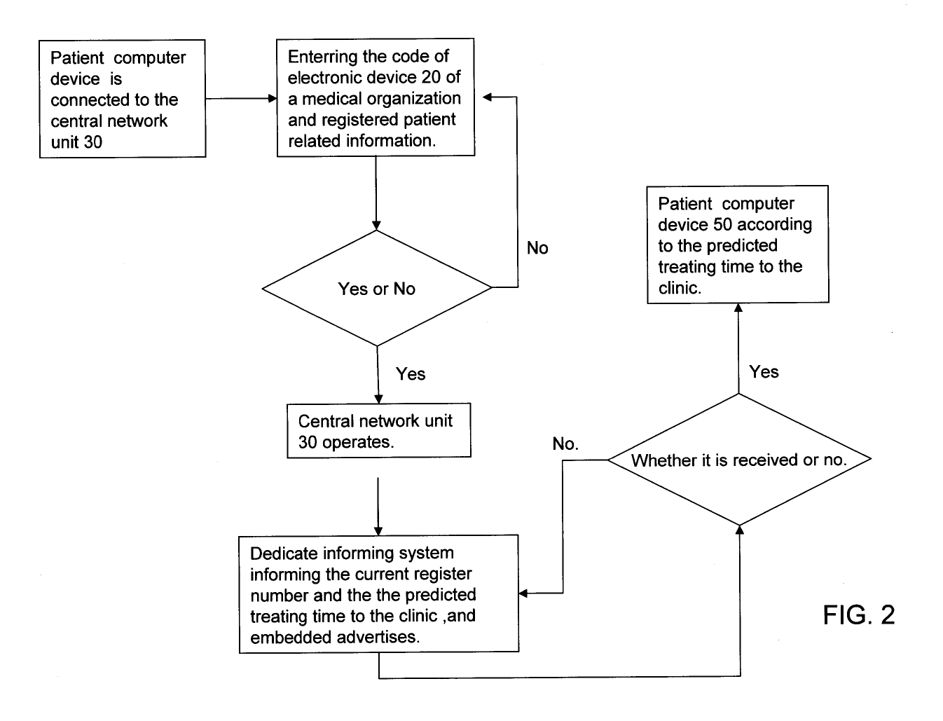

The present invention relates to a network station with functions of medial register number and medical messages informing. With reference to FIGS. 1 and 2, the network station of the present invention includes a server 10. The server 10 includes a memory 11, a central processing unit (CPU) 12, and other related input/output devices. The memory 10 stores the data about the software of the present invention, and the data about the medial organizations, advertise providers, and patients

At least one electronic device 20 of a medical organization is included. The medical organization may be one of clinics and hospitals and other related organizations. The electronic device 20 of a medical organization is connected to the server 10 of the present invention by wired connection or wirelessly. The medical organization transfer messages to the server 10 through a network (for example through internet). The medical messages includes, for example, the next register number, the predicted treating speed, the related information about the medical organization, the working time of the doctors, etc. The electronic device 20 of the medical organization can download the software about the operation of the present invention from the network station of the present invention, or installed from electronic media, such as optical disks, etc. Or the medical organization uploads data to the server 10 of the present invention based on the data transfer protocol determined by the present invention. Then the server 20 processes the related operation. The current register numbers may be acquired by input operation of the medical persons or from other current used register number display devices.

Preferable, in the present invention, there are a plurality of electronic devices which are from a plurality of respective medical organizations.

The present invention also includes a dedicate informing system for informing the specific information to specific patients, such as the current register number related to the patient to be treated. In this system, the connection way for example phone number, to the patient must be inputted.

A central network unit 30 is built mainly from the server 10. The central network unit 30 is connected to the at least one electronic device 20 for receiving the information from the electronic device 20, such as the next register number, the predicted treating speed, the related information about the medical organization, the working time of the doctors, etc. These information are displayed or transferred to those needed these information.

Similarly, in the dedicate informing system, in the transferring of the register number, the register number can be informed to the succeeding patients by a specification indication way, for example, the register number is transferred to the patient to be treated by short messages, or displayed on the monitor of the patient by a way attracted the attention of the patient, or is reported by the patient by a phone call.

Besides, the dedicate informing system provides a quick accessing function. The patient can get the information from a quick way, such as calling by a set of special number by a handset for getting the current register number about his (or her doctor). Or the patient can click a specific icon on the web page of the central network unit for getting the information.

The central network unit 30 further includes a protocol unit about register number display device. The protocol causes the data communication between the register number display device and the central network unit 30 so that the data in the register number display device can be transferred to the central network unit 30. The medical person does not need to input the information to the central network unit 30.

At least one patient computer device 50 is connected to the central network unit 30 for receiving the data from the central network unit 30, such as the next register number, the predicted treating speed, the related information about the medical organization, the working time of the doctors, etc. The patient computer device 50 may be one of a handset, a PDA, a notebook computer, a desktop computer, a net TV and other electronic device which can receive and display messages.

Similarly, the patient computer device 50 can receive the message of the dedicate informing system so as to assure the current register number and the predict treating time for the patient so as to avoid the time waste in waiting the doctor to treat his decrease. Sound emission is used to alert the patient to inform the register number.

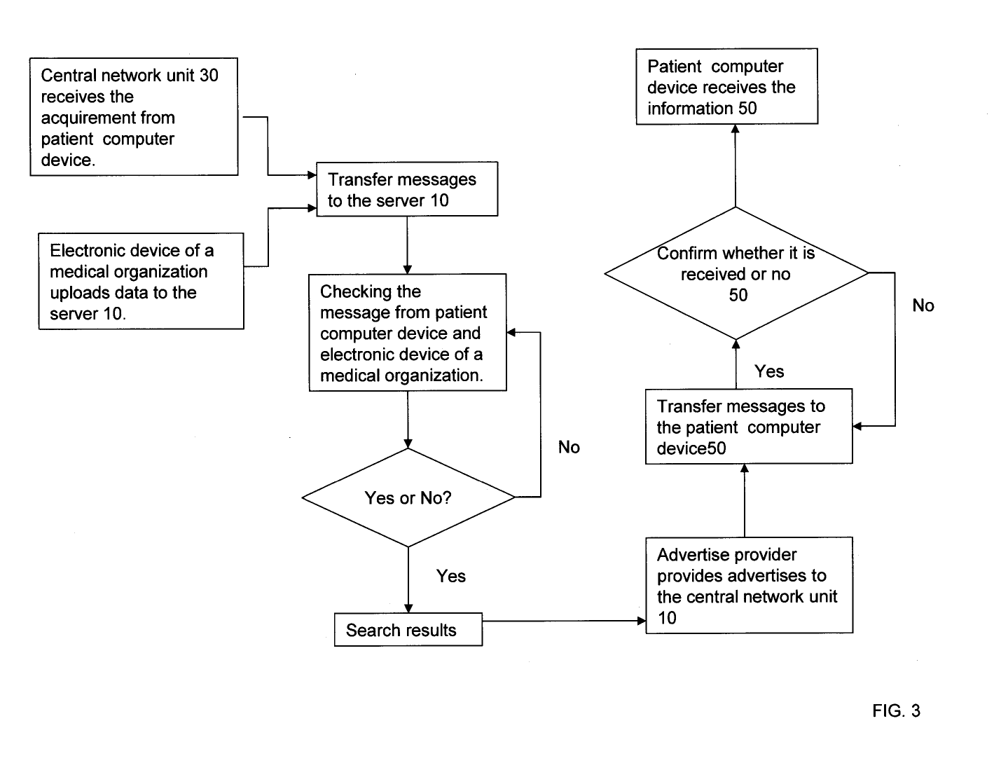

At least advertise provider 40 is connected to the central network unit 30. The advertise provider 40 provides advertise to the central network unit 30 so that the advertise are transferred to the patient computer device 50 to be displayed to have the effect of advertisement. The advertise message is displayed with other medical information so as to increase the effect of advertisement, as illustrated in FIG. 3, it is illustrated that the advertisement are added to the operation of the present invention.

In the present invention, the patient computer device 50 causes that the patients can know the current register number of a specific doctor so that the patient can predict the time to the medical organization. Thus the patient does not need to wait the doctor. Besides, the advertise provider 40 can provide advertise to the central network unit 30 and then the advertisement is embedded into the messages to the patient so as to display on the patient computer device 50.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A network station system with functions of medial register number and medical messages informing, comprising:
a server having a memory, a central processing unit (CPU), and other related input/output devices; the memory storing the data about operation software, data about medial organizations, advertise providers, and patient;
at least one electronic device of a medical organization; the electronic device being connected to the server; the medical organization transferring messages to the server through a network; the medical messages including the current register number, the predicted treating speed, the related information about the medical organization, the working time of the doctors;
a central network unit; the central network unit being connected to the at least one electronic device for receiving the information from the electronic device; these information being displayed or transferred to those needed these information; and
at least one patient computer device connected to the central network unit for receiving the data from the central network unit.

2. The network station system with functions of medial register number and medical messages informing as claimed in claim 1, wherein the medical messages includes current treated register numbers, predicted treating speeds, related information about the medical organization, working time of doctors.

3. The network station system with functions of medial register number and medical messages informing as claimed in claim 1, wherein the electronic device of the medical organization downloads software about operations of the system from the network station, or the software is installed from electronic media; or the medical organization uploads data to the server.

4. The network station system with functions of medial register number and medical messages informing as claimed in claim 1, wherein the current treated register numbers is acquired from input operation of the medical persons or from other current used register number display devices.

5. The network station system with functions of medial register number and medical messages informing as claimed in claim 1, wherein the central network unit includes a dedicate informing system for informing the specific information to specific patients.

6. The network station system with functions of medial register number and medical messages informing as claimed in claim 5, wherein the specific information is the current register number related to the patient to be treated.

7. The network station system with functions of medial register number and medical messages informing as claimed in claim 1, wherein the patient computer device accesses to the dedicate informing system by using a set of specific number to know the register number and other related information.

8. The network station system with functions of medial register number and medical messages informing as claimed in claim 1, wherein the patient computer device is one of a handset, a PDA, a notebook computer, a desktop computer, a net TV and other electronic device for receiving and displaying messages.

9. The network station system with functions of medial register number and medical messages informing as claimed in claim 7, wherein the register number is informed to the patients by a specific indication way.

10. The network station system with functions of medial register number and medical messages informing as claimed in claim 10, wherein the specific indication way is one of short messages, high light on a predetermined area on a screen of a patent computer device and sound emission from a screen of patient computer device.

11. The network station system with functions of medial register number and medical messages informing as claimed in claim 1, wherein at least advertise provider is connected to the central network unit for providing advertises to the central network unit so that the advertisements are transferred to the patient computer device to be displayed so as to have the effect of advertisement.

12. The network station system with functions of medial register number and medical messages informing as claimed in claim 1, wherein the central network unit further includes a protocol unit for a register number display device; the protocol causes the data communication between the register number display device and the central network unit so that the data in the register number display device is transferred to the central network unit.
